(19) United States
(12) Patent Application Publication
(10) Pub. No.: US 2014/0082696 A1
(43) Pub. Date: Mar. 20, 2014

(54) DISTANCE BOUNDING PROTOCOL WITH MINIMAL VARIANCE PROCESSING

(71) Applicants: Boris Danev, Zurich (CH); Srdjan Capkun, Zurich (CH); David Basin, Ruschlikon (CH)

(72) Inventors: Boris Danev, Zurich (CH); Srdjan Capkun, Zurich (CH); David Basin, Ruschlikon (CH)

(73) Assignee: ETH ZURICH, ZURICH ETH-ZETRUM (CH)

(21) Appl. No.: 13/984,804

(22) PCT Filed: Feb. 13, 2012
(86) PCT No.: PCT/CH12/00039

§ 371 Date: Nov. 15, 2013

(30) Foreign Application Priority Data
Feb. 11, 2011 (EP) 11001132..7

(51) Int. Cl. G06F 21/31

(52) U.S. Cl. CPC G06F 21/31
USPC 726/3

(57) ABSTRACT

The method for communicating between a first device and a second device, the first and second devices being structured and configured for communicating via a communication channel by exchanging messages, comprises the steps of
a) the first device transmitting a challenge message to the second device;
b) the second device, in reaction to receiving the challenge message:
   b1) carrying out a processing on the received challenge message;
   b2) generating a response message, said response message being derived in dependence of said challenge message; and
   b3) transmitting the response message to the first device;
c) the first device receiving the transmitted response message and determining a time elapsed between the transmitting of the challenge message and the reception of the response message;
d) the first device computing, in dependence of said determined time, of a value indicative of a travelling speed of the challenge and the response messages and of a value indicative of a processing time assumed to be required by the second device for carrying out said processing, a value relating to a distance between the first and the second device.

### TECHNICAL FIELD

The invention relates to the field of wireless communication, in particular to the field of wireless communication networks, more particularly to authentication and access control for or to authenticated ranging of devices controlled by wireless communication. It relates to methods and apparatuses according to the opening clauses of the claims.

### BACKGROUND OF THE INVENTION

Distance bounding, as a concept, was first proposed by Brands and Chaum in “Distance bounding protocols” by Stefan Brands and David Chaum, in EUROCRYPT '93, pages 344-359, Secaucus, N.J., USA, 1994, Springer-Verlag New York, Inc. They introduced techniques enabling a verifier to determine an upperbound on the physical distance to a prover. In addition, they considered the case where the verifier also authenticates the prover in addition to establishing the distance bound.

### SUMMARY OF THE INVENTION

The invention allows to enable secure distance bounding and/or distance ranging. This involve two parties (devices), a verifier V or first device and a prover P or second device, usually equipped with analog and digital processing units.

The method for communicating according to the invention is described in the patent claims, as are corresponding devices and systems according to the invention. Yet, certain aspects of the invention are described in the following.

The method for communicating between a first device and a second device, the first and second devices being structured and configured for communicating via a communication channel by exchanging messages, comprises the steps of
a) the first device transmitting a challenge message to the second device;
b) the second device, in reaction to receiving the challenge message:
   b1) carrying out a processing on the received challenge message;
   b2) generating a response message, said response message being derived in dependence of said challenge message; and
   b3) transmitting the response message to the first device;
c) the first device receiving the transmitted response message and determining a time elapsed between the transmitting of the challenge message and the reception of the response message;
d) the first device computing, in dependence of said determined time, of a value indicative of a travelling speed of the challenge and the response messages and of a value indicative of a processing time assumed to be required by the second device for carrying out said processing, a value relating to a distance between the first and the second device.

In particular, it can be provided that said processing time is not time-dependent and in particular independent of the received challenge message. The processing time being not time-dependent (or independent of time) means that processing carried out at different times requires (with high precision) the same processing time.

The one device referred to as verifier, is structured and configured for communicating via a communication channel with the further device, referred to as prover, the verifier comprising a transceiver for sending and receiving messages via said communication channel, the verifier being structured and configured for
exchanging messages with the prover via said communication channel;
transmitting a challenge message to the prover;
receiving a response message transmitted by the prover, the response message being obtained from the challenge messages by processing;
determining a time elapsed between the transmitting of the challenge message and the reception of the response message;
computing a value relating to a distance between the verifier and the prover, wherein said computing is carried out in dependence of said determined time, of a value indicative of a travelling speed of the challenge and the response messages and of a value indicative of a processing time assumed to be required by the prover for carrying out said processing;
depending on the computed value, to accept or not accept data from the prover, and optionally also to control access to the verifier.

The other device, referred to as prover, is structured and configured for communicating via a communication channel with a further device, referred to as verifier, the prover comprising a transceiver for sending and receiving messages via said communication channel, the prover being structured and configured for
exchanging messages with the verifier via said communication channel;
receiving a challenge message transmitted by the verifier;
in reaction to receiving the challenge message,
   carrying out a processing on the received challenge message;
   generating a response message, said response message being derived in dependence of said challenge message; and
   transmitting the response message to the verifier.

The distance bounding system according to the invention comprises a first device being a device according to the invention, referred to as verifier, and a second device being a device according to the invention, referred to as prover.

It can be provided that the processing is carried out in a processing unit of the prover.

It is to be noted that for carrying out the invention, it can be sufficient to transmit all messages via one and the same communication channel, in particular wherein that communication channel can be full duplex or possibly even a half duplex communication channel.

Further embodiments and advantages emerge from the dependent claims and the figure.

### BRIEF DESCRIPTION OF THE DRAWING

Below, the invention is described in more detail by means of the included drawing. The figure shows:

FIG. 1 a schematic diagram of the phases with associated message exchanges.

### DETAILED DESCRIPTION OF THE INVENTION

The method involves two parties, a verifier V and a prover P, equipped with analog and digital processing units, who carry out a usually three phase protocol. The phases are a setup phase, a measurement phase, and an optional validation phase, i.e., skipping the validation phase, the protocol may be a two phase protocol. There is a time-critical part to the protocol. The time-critical part of the protocol is the measurement phase, where, in an optimum case, the prover's computation must be predictable and have negligible variance (computation time variance). More generally: The processing applied by the prover P during the measurement phase should be known in advance with a high degree of accuracy and precision (repeatability). The validation phase need only be used when authentication is required.

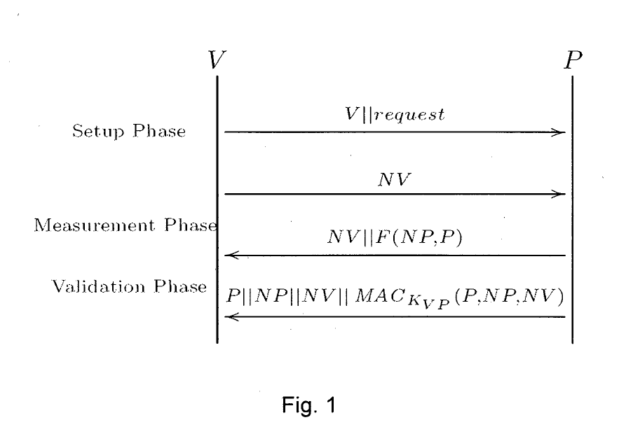

Schematically the phases with associated message exchanges are depicted in FIG. 1 where “∥” denotes concatenation, and
V denotes the verifier,
“request” denotes a request or request message,
NV denotes a nonce chosen by the verifier,
P denotes the prover and its identity (identity data), respectively,
NP denotes a nonce chosen by the prover,
F(NP,P) denotes a function of NP and P,
MAC_{Kvp} denotes a message authentication code based on a shared symmetric key K_{VP}, or, more generally, an authenticated version of the data concerned.

A nonce is, as well known in the art, a number only used once.

The steps taken in the phases are as follows

Setup Phase:
The verifier V identifies itself. And, optionally, a request is sent, too. In other words, a message comprising data identifying the verifier are transmitted from verifier V to prover P.
After receiving this first message, the prover P generates a nonce NP and computes a function F on NP and additional information such as his identity P (data identifying prover P). Function F may be trivial and usually is at least very simple. This information (F(NP,P)) is stored by the prover in a memory buffer for subsequent use in the measurement phase. Typical implementations of F include concatenation or bitwise exclusive-or. Note that this function F uses information that is independent of the verifier's challenge (nonce) NV (sent later in the measurement phase) and hence can be computed during the setup phase. This contributes to the security of the process, since, as will become clear below, in the response transmitted by the prover during the measurement phase, no time is wasted computing F(NP,P) after transmitting NV to verifier V.

Measurement Phase:
The verifier sends a challenge nonce NV to the prover.
Upon receiving the challenge, the prover sends NV back to the verifier. In other words, in reaction to receiving the challenge, nonce NV is transmitted to verifier V as quickly as technically possible for prover P. Note that the arrival of the challenge at the prover can be detected with minimal digital signal processing, for example based on energy detection, e.g., within a particular band. This can make possible a simple and high-speed detection that the transmitting-back of the nonce has to be initiated. Also that challenge does not need to be demodulated to be returned (sent back to the verifier) by the prover. This can make possible a particularly early transmission of the nonce back from prover P to verifier V. The prover also records NV for later demodulation in the non-time-critical validation phase, at least in case the validation phase shall be provided.
After the prover completes the transmission of the verifier's challenge, it (immediately) digitally modulates its precomputed buffer content (so as to make a transmission thereof possible) and also sends this to the verifier. In this way, it concatenates its own response to the verifier's nonce, at least when considered in a specific view.
The verifier measures the time taken between the transmission of its nonce NV and its reception of the prover's response. Verifier V comprises a time measurement unit for determining the time elapsed between the sending of the challenge signal and the reception of the response sent by the prover. E.g., the time between the beginning of the sending of the challenge and the beginning of the reception of the response can be measured, or the time between the end of the sending of the challenge and the end of the reception of the response, or a cross-correlation function may be applied to the challenge and to the response, mutually shifting them in time, the time shift at the cross-correlation maximum indicating the sought time (with high accuracy). The measured time allows to determine an upper limit for the distance between verifier and prover, thus making distance bounding possible.

Validation Phase (Optional):
The prover authenticates all previous information, i.e. P, NP and NV. In the figure (FIG. 1), this is depicted using a MAC (message authentication code) based on a shared symmetric key K_{V P}. Authentication could alternatively be based on a digital signature (thus involving an asymmetric key procedure) or differently.
The verifier verifies this information, thereby authenticating the prover.

Based on (a) the time taken in the measurement phase, i.e. the measured time between the transmission of NV by verifier V and reception of NV (in the prover's response) and (b) the time estimated for the prover to produce its response (i.e. an estimated processing time), after completion of the measurement phase, the verifier V can compute an upper bound on its distance to the prover. This way, data from a prover located, according to the computed upper bound, farther away than a pre-determined distance, can be rejected or ignored. The precision of the (computed) bound depends on the accuracy of the estimation of (b). Therefore, the processing time needed by the prover to “reflect” (send back) the nonce NV should be constant, i.e. have a high reproducibility, i.e. a low variance. By using digital and analog processing with predictable time requirements, it is possible to estimate (b) accurately where the variance over multiple runs of the measurement phase is negligibly small.

The function F should be known to both, verifier V and prover P. This can be provided, e.g., already during manufacture of verifier V and prover P, or during setup (by transmitting one or more messages indicative of the Function F that will be used by the prover). Data used for the authentication are known to both, verifier and prover, which will be accomplished before the setup phase, usually during manufacture of verifier V and prover P. E.g., a shared key (as would be the case when using MAC), more particularly a shared symmetric key, or an asymmetric key (as would be the case when using a digital signature), can be initially provided in both, verifier and prover.

The provision and transmission of nonce NP (the prover's nonce) is generally optional. NP can be dispensed with. Including NP (as discussed above and shown in FIG. 1) can make possible to provide a session key or data identifying the current communication session between verifier and prover comprising NP and, more particularly also comprising NV.

An advantage of transmitting, in the measurement phase, not only NV but (soon) afterwards also F(NP,P) or, more generally, data comprising an identifier identifying P, is that this contributes to the security of the communication, namely in that a third party trying to pretend to be prover P would have to be very fast for being able to send corresponding data (such as a F(NP′,P′)) before prover P transmits F(NP,P). The computation of F(NP,P) in advance (during the setup phase already) allows the prover to transmit F(NP,P) (merely read out of the buffer) immediately after NV or at least sooner than if F(NP,P) had been computed only after the transmission or after the reception of NV.

As to the minimal computation/processing and the “negligible variance”: The amount of processing involved should deliberately be chosen to be very small, e.g., avoiding a demodulation of a challenge message, and the processing time variance should be so small that it can be neglected, e.g., with respect to the processing time itself E.g., carrying out the (same) processing several times will result in deviations of the respective processing times which are smaller than the processing time itself by at least a factor of 10, or rather by at least a factor of 100, or even by at least a factor of 1000. But generally spoken, the acceptable processing time variance (or negligible processing time variance) depends on the application in which the invention shall be used. In case the communication channel has a signal propagation speed of speed of light, acceptable processing time variances will typically be at most 100 ns or rather at most 10 ns or even at most 1 ns. As usually will be the case, access to or control of verifier V by prover P shall be allowed only if a value relating to the distance between verifier V and prover P as computed by verifier V is indicative of a distance smaller than a pre-defined maximum distance referred to as dmax. With c designating the signal propagation speed of the communication channel, the acceptable processing time variance, i.e. the processing time variance which would be considered negligible, would usually be at most 0.2 times dmax/c or rather at most 0.1 times dmax/c or even at most 0.05 times dmax/c.

The method's application areas include those systems controlling access to objects (e.g., vehicles or buildings) and services (e.g., for vehicles, medical devices, or computing devices). The method can be also used for localization of devices by computing their position based on multilateration schemes performing time-of-flight measurements with a set of base stations.

By means of the invention, it is possible to determine a distance between verifier and prover and thus to ensure that a prover is located within a given maximal distance from the verifier. Furthermore, malicious attacks trying to interfere are effectively impeded.

Aspects of the embodiments have been described in terms of functional units. As is readily understood, these functional units may be realized in virtually any number of hardware and/or software components adapted to performing the specified functions.

Furthermore, the following embodiments are disclosed, wherein each of them may be, as far as logically possible, be combined with the invention as described elsewhere in the present patent application.

### Method Embodiments

Embodiment 1. A method for communicating between a first device and a second device, that is preferably a reader for reading data from the first device and optionally destined for controlling the first device, the method comprising the steps of
the first and second device communicating by exchanging messages based on signals over a communication channel;
the first device sending a challenge message to the second;
the second device sending upon reception of the challenge message a response message to the first device;
the first device measuring the time elapsed between the sending of the challenge message to the reception of the response message;
the first device computing its distance to the second device based on this time, knowledge about travelling speed of the challenge and the response message and the processing delay that the second device adds to generate and send the response message;
characterised in that the second device has a known calculation time for its response with negligible variance.

Embodiment 2. The method of embodiment 1, comprising the further step of
the first and second device by exchanging the messages, establish a shared secret key.

Embodiment 3. The method of embodiment 1 or embodiment 2, comprising the further steps of
defining a fixed nonce length for the first device and a fixed nonce length for the second device;
the first and second device each picking a random nonce of the defined lengths;
the first device encoding its chosen nonce into the challenge message; the second device responds with its own nonce with a known computation time that is independent of the challenge nonce.

Embodiment 4. The method of embodiment 3, comprising the further steps of
given a cryptographic key (either a shared secret symmetric key or using public key cryptography), the second device authenticating the nonce it received as well as its own nonce using the key (e.g., signing with its private key or producing a message authentication code with the shared symmetric key) and thus establishing an additional message;
the second device sending that additional message to the first device;
the first device verifying the additional message by knowledge of his chosen nonce and the previously received nonce chosen by the second device.

Embodiment 5. The method of one of the preceding embodiments, wherein all of the communication channels are based on RF communication.

Embodiment 6. The method of one of the preceding embodiments, wherein the step of controlling access of the second device to the first device, in addition to the distance, takes into account credential information, such as a device's identity.

Embodiment 7. The method of one of the preceding embodiments, wherein the first device comprises two or more levels of access, and the method comprises the further step of
the first device controlling access to the different levels of access depending on the value of the computed distance.

### Device Embodiments

Embodiment 8. A first device, configured to communicate with a further device, comprising
a transceiver for sending and receiving messages;
the device being configured to
   exchange messages;
   to compute the distance to the further device based on communication signal delays and caused by the difference in signal propagation velocities and estimated processing time of the other device; and
   depending on the computed distance, to accept data from the further device and optionally also to control access to the device.

Embodiment 9. A second device, configured to communicate with a further device, comprising
a transceiver for sending and receiving messages;
digital and analog processing units to produce and transmit the response with predictable time and negligible variance, in particular comprising:
   a buffer in which the response to the initial challenge is precomputed and stored;
   a unit capable of receiving the initial challenge with minimal digital signal processing;
   a unit that transmits the original challenge back to the first device along with the stored response, where the processing time between the challenge reception and the response is predictable and with negligible variance.

Embodiment 10. A second device according to embodiment 9, where the buffer is filled computing a function of its own nonce and additional information such as its name, in particular using concatenation or bitwise exclusive-or.

Embodiment 11. A second device according to embodiment 9 or 10, where the unit capable of receiving the initial challenge is based on energy detection within a particular band.

Embodiment 12. A second device according to any of the embodiments 9-11, where the receiving unit is linked to the transmitting unit so that the challenge is reflected back without demodulation.

Embodiment 13. A second device according to any of the embodiments 9-12, where the transmitting unit concatenates the contents of the buffer immediately after reflecting back the received challenge.

1. A method for communicating between a first device and a second device, the first and second devices being structured and configured for communicating via a communication channel by exchanging messages, the method comprising the steps of:
a) the first device transmitting a challenge message to the second device;
b) the second device, in reaction to receiving the challenge message:
b1) carrying out a processing on the received challenge message;
b2) generating a response message, said response message being derived in dependence of said challenge message; and
b3) transmitting the response message to the first device;
c) the first device receiving the transmitted response message and determining a time elapsed between the transmitting of the challenge message and the reception of the response message;
d) the first device computing, in dependence of said determined time, of a value indicative of a travelling speed of the challenge and the response messages and of a value indicative of a processing time assumed to be required by the second device for carrying out said processing, a value relating to a distance between the first and the second device.

2. The method according to claim 1, wherein said processing time is not time-dependent.

3. The method according to claim 1, wherein said processing time has a negligible variance.

4. The method according to claim 1, wherein said response message is generated without demodulating the challenge message.

5. The method according to claim 1, comprising the step of:
g) the first device generating a nonce referred to as nonce NV;
wherein said challenge message comprises nonce NV; and
wherein said response comprises nonce NV.

6. The method according to claim 1, comprising the step of:
h) the second device computing, prior to receiving said challenge message, a data set and storing said data set in a memory buffer comprised in the second device.

7. The method according to claim 1, comprising the step of:
i) the first device transmitting, prior to transmitting said challenge message, an initial message comprising data identifying the first device.

8. The method according to claim 5, comprising the step of:
h) the second device computing, prior to receiving said challenge message, a data set and storing said data set in a memory buffer comprised in the second device;
wherein step h) is carried out after the reception in the second device of the initial message.

9. The method according to claim 6, wherein said response message comprises said data set.

10. The method according to claim 5, comprising the step of:
h) the second device computing, prior to receiving said challenge message, a data set and storing said data set in a memory buffer comprised in the second device;
wherein said response message comprises said data set; and
wherein said response message comprises nonce NV and concatenated thereto, said data set.

11. The method according to claim 6, wherein said data set is derived in dependence of data identifying the second device.

12. The method according to claim 1, comprising the steps of:
j) the second device authenticating data comprised in the response message;
k) the second device transmitting the authenticated data to the first device; and
l) the first device verifying the transmitted authenticated data.

13. The method according to claim 12, comprising enabling controlling said first device.

14. The method according to claim 1, enabling controlling said first device, allowing access to said first device, by said second device only provided that said value relating to the distance between the first and the second device is indicative of a distance smaller than a pre-defined maximum distance.

15. The method according to claim 1, wherein the second device is structured and configured for controlling the first device and/or is a reader for reading data from the first device.

16. The method of claim 1, wherein said communication channel is based on RF communication.

17. A device, referred to as verifier, structured and configured for communicating via a communication channel with a further device, referred to as prover, the verifier comprising a transceiver for sending and receiving messages via said communication channel, the verifier being structured and configured for:
exchanging messages with the prover via said communication channel;
transmitting a challenge message to the prover;
receiving a response message transmitted by the prover, the response message being obtained from the challenge messages by processing;
determining a time elapsed between the transmitting of the challenge message and the reception of the response message;
computing a value relating to a distance between the verifier and the prover, wherein said computing is carried out in dependence of said determined time, of a value indicative of a travelling speed of the challenge and the response messages and of a value indicative of a processing time assumed to be required by the prover for carrying out said processing;
depending on the computed value, to accept or not accept data from the prover; and
depending on the computed value, optionally to control access to the verifier.

18. The device according to claim 17, being furthermore structured and configured for generating a nonce;
wherein said nonce is comprised in said challenge message.

19. The device according to claim 17, being furthermore structured and configured for transmitting, prior to transmitting said challenge message, an initial message comprising data identifying the verifier.

20. The device according to one of claim 17, being furthermore structured and configured for:
receiving a message comprising authenticated data; and
verifying said authenticated data.

21. The device according to claim 20, being furthermore structured and configured for enabling a controlling of the verifier, allowing to access the verifier.

22. The device according to claim 17, being furthermore structured and configured for transmitting to said prover, prior to said transmitting said challenge message to the prover, an initial message.

23. A device, referred to as prover, structured and configured for communicating via a communication channel with a further device, referred to as verifier, the prover comprising a transceiver for sending and receiving messages via said communication channel, the prover being structured and configured for:
exchanging messages with the verifier via said communication channel;
receiving a challenge message transmitted by the verifier;
in reaction to receiving the challenge message,
carrying out a processing on the received challenge message;
generating a response message, said response message being derived in dependence of said challenge message; and
transmitting the response message to the verifier.

24. The device according to claim 23, wherein said processing time is not time-dependent.

25. The device according to claim 23, wherein said processing time has a negligible variance.

26. The device according to claim 23, wherein said processing is carried out without demodulating the challenge message.

27. The device according to claim 23, comprising a buffer memory and being furthermore structured and configured for:
receiving, prior to receiving the challenge message, an initial message, said initial message in particular identifying the verifier;
in reaction to receiving said initial message:
generating a nonce;
obtaining a data set by applying a function to said nonce and to data identifying the prover,;
storing said data set in said buffer memory.

28. The device according to claim 27, wherein said response message comprises data derived from the challenge message.

29. The device according to claim 27, being furthermore structured and configured for:
authenticating data comprising
said data identifying the prover;
said nonce; and
data derived from the challenge message; and
transmitting the authenticated data to the verifier.

30. A distance bounding system comprising a first device being a device according to claim 17, further comprising a second device, said second device referred to as prover, structured and configured for communicating via a communication channel with a further device, referred to as verifier, the prover comprising a transceiver for sending and receiving messages via said communication channel, the prover being structured and configured for:
exchanging messages with the verifier via said communication channel;
receiving a challenge message transmitted by the verifier;
in reaction to receiving the challenge message,
carrying out a processing on the received challenge message;
generating a response message, said response message being derived in dependence of said challenge message; and
transmitting the response message to the verifier.

31. The method according to claim 2, wherein said processing time is independent of the received challenge message.

32. The method according to claim 5, wherein said challenge message is substantially comprised of nonce NV.

33. The method of claim 8, wherein step h) is carried out in reaction to the reception of the initial message in the second device.

34. The method of claim 11, wherein said data set is derived in dependence of data identifying the second device and in dependence of a nonce generated by a second device, referred to as nonce NP.

35. The method of claim 11, wherein said data set is derived by applying a function to data identifying the second device and to a nonce generated by the second device, referred to as nonce NP.

36. The method according to claim 12, comprising enabling a accessing said first device, allowing access to said first device, by said second device only provided that a result of said verifying mentioned in step 1) is positive.

37. The device according to claim 22, wherein said initial message comprises data identifying the verifier.

38. The device according to claim 29, wherein said authenticating and said transmitting is carried out after transmitting said response message.
